(19) United States
(12) Patent Application Publication
(10) Pub. No.: US 2003/0146298 A1
(43) Pub. Date: Aug. 7, 2003

(54) Dual spray gun for painting and cleaning

(76) Inventor: Wuu-Cheau Jou, Da Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/061,207

(22) Filed: Feb. 4, 2002

(51) Int. Cl. A62C 13/62; B05B 9/03

(52) U.S. Cl. 239/302; 239/433

(57) ABSTRACT

The present invention relates to a dual spray gun for painting and cleaning, and more especially to a combined tin and pipe dual spray gun for painting and cleaning, which can be used separately and independently, and increase the working radium at willing and can be used in unitized construction, depending on the working environments. The present invention includes a T-shaped main body, which is connected with an air blow-gun with the back end, and connected to a blow head with the front end, and secured a pipe on the vertical sucking tap hole, and a tank is connected on the tip end of said pipe to construct a combined tin and pipe structure; said tank can be connected on said T-shaped main body directly individually to construct a tin structure; if the pipe is connected on the T-shaped main body individually to construct a pipe structure; so the three structures can meet the necessaries of any working environment so that the working radium is extended infinitely.

### BACKGROUND OF THE INVENTION

1. Field of the Invention

The present invention relates to a dual spray gun for painting and cleaning, and more especially to a dual spray gun that combine tin and pipe sucking methods into one set, in which they can be used separately and independently, and in series connection so as to improve more painting or cleaning operation facility.

2. Description of Prior Art

In accordance with the conventional dual spray gun for painting and cleaning is used for painting priming paint or cleaning various work-pieces, whatever sucking up paint or cleaner, according to the method of sucking, the most of the dual spray guns can be divided into tin dual spray gun 11, as shown in FIG. 1, and pipe dual spray gun 12, as shown in FIG. 2, in design for suiting to different working environments. For example, said tin dual spray gun 11 carrying with smaller paint or cleaner is used in smaller working area painting or cleaning in the shorter working period without needing large scale paint or cleaner, but it has shortcomings, just like heavier so as to limit wrist of hand dexterous and quick in operating action and to make wrist tire easily and working period shortcut. And said pipe dual spray gun 12 holding with a longer pipe 121 can apply a larger tank at the another end of said pipe 121 supplying more paint or cleaner sucked up and sprayed out for meeting the necessary of larger working area, meanwhile the working radium is increased due to applying said pipe 121. In the mechanism of said pipe dual spray gun, by the larger tank providing more paint or cleaner, the shortcoming of the interruption caused by the ullaged liquid in the tin can be overcome, instead, enough mount of liquid supplied and larger working area processed, and longer working radium achieved by means of said longer pipe 121. Although it has so many merits, but there are some demerits existing obviously, for example, because the worker has to often move for adjusting the position in working time, sometimes he or she forgets the length limit of said pipe 121 as moving to overrun the length of the pipe 121 so that the pipe 121 is withdrew out from the surface of the liquid in the tank to cause spraying process interrupted unexpectedly to break the process, further to affect the quality of painting and delay the working term. And on the other hand, the tank 13 is easy to be overturned by dragging pipe 121 or run into by the passing worker casually to cause the paint or cleaner liquid running off, so the operator should have to pay attention on the positions of the tank 13 and the pipe 121 all the time so as to distract his attention on processing, further to affect the process quality and job quality.

Above-mentioned tin and pipe spray guns are designed professionally in independence, if the user have to use the both methods in job, he or she should buy the two kinds of dual spray guns for painting and cleaning, because they can not be used convertibly or alternatively, therefore, the cost must be higher, and the operation is inconvenience, so if the merits of the both kinds of spray guns can be combined in one set, it must be expected.

### OBJECTS AND SUMMARY OF THE INVENTION

It is therefore a main object of the present invention to provide a combined tin and pipe dual spray gun for painting and cleaning, which can be used convertibly and alternatively in tin style and pipe style with low cost, and improve the facility of the operation.

### BRIEF DESCRIPTION OF THE DRAWINGS

FIG. 1 is a side view of a conventional tin dual spray gun.

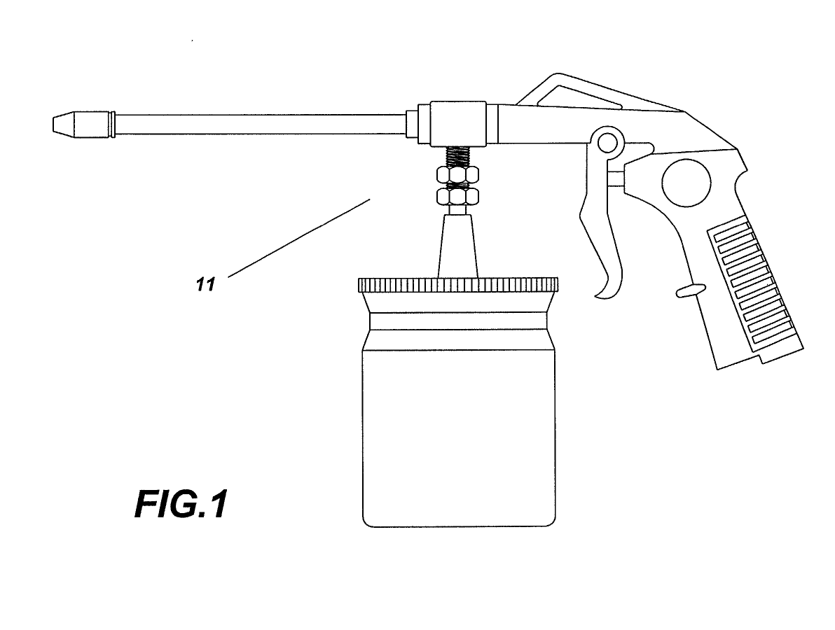

FIG. 2 is a side view of a conventional pipe dual spray gun.

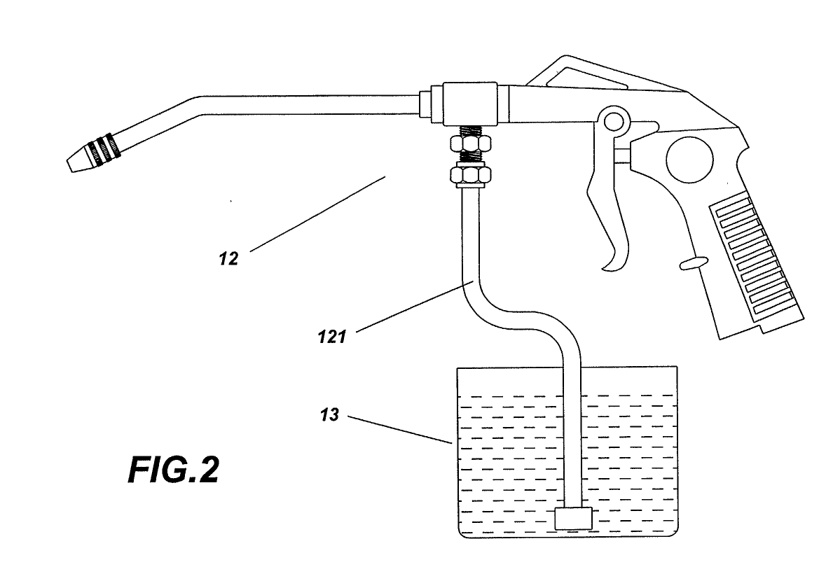

FIG. 3 is an exploded view of the present invention.

FIG. 4 is a cross-section view of the present invention.

FIG. 5 is a scheme showing the use state in pipe method of the present invention.

FIG. 6 is a scheme showing the use state in tin method of the present invention.

### DETAILED DESCRIPTION OF PREFERRED EMBODIMENTS

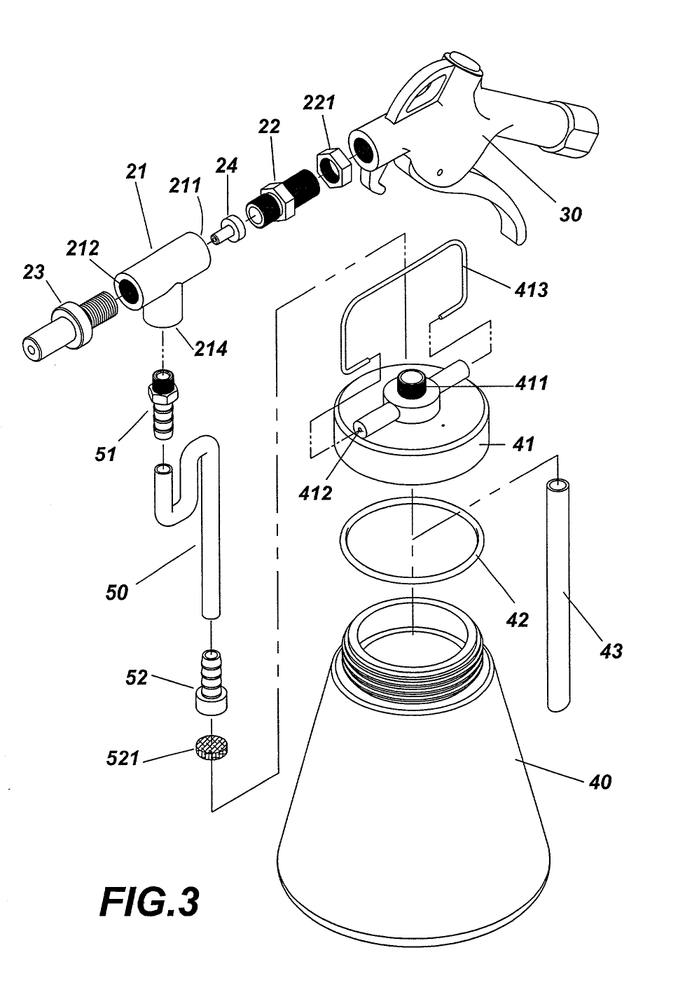

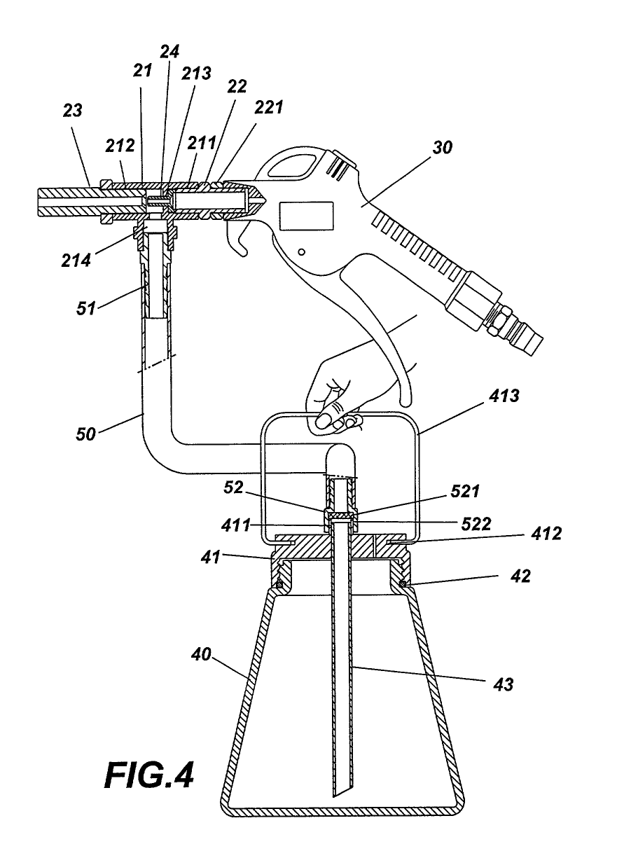

Referring to FIG. 3 and FIG. 4, the present invention is comprised of a three-way T-shaped main body 21 having an inlet tap hole 211 for securing to an air blowgun 30 via a combined bolt 22 and a locating nut, and a front tap hole 212 for securing a blow head 23, and the downward sucking tap hole 214 connecting to said front tap hole 212, and a through-hole 213 connecting said front tap hole 212 and said sucking tap hole 214 to said inlet tap hole 211 for locating an atomized nozzle 24 from the inlet tap hole 211 side so that the tip end of said nozzle 24 stretch in the inside of said front tap hole 212 and above said sucking tap hole 214; said sucking tap hole 214 is used for securing on a pipe connection 51 at one end of a pipe 50, and a filter connection 52 holding a filter leaf 521 for filtering foreign is built upon the another end of said pipe 50, and there is an internal screw 522 built on the inside of said filter connection 52 for securing on a bolt 411 with a through-hole at the cap 41 of a tank 40 and sealing with an O-ring 42, and said bolt 411 with the through-hole built on the top side of said cap 41 also can be secured on said sucking tap hole 214 of said T-shaped main body 21 directly, and said cap 41 extends a sucking tube at the bottom side connecting to the through-hole of said bolt 411 for sucking up the paint or cleaner contained in said tank 40; said cap 41 also has a pair of pivoting holes for hanging on a C-shaped handle 413 for carrying over.

Above-mentioned mechanism of the combined tin and pipe dual spray gun provided by the present invention can be used in individual tin spray gun or independent pipe spray gun, or combined tin and pipe dual spray gun in practice as following:

1. Using in combined tin and pipe method:

referring to FIG. 3 and FIG. 4, said T-shaped main body 21 connects to said pipe connection 51 of said pipe 50 as the same way as above-described, and the another end of said pipe 50 via said filter connection 52 connects to the cap 41 of said tank 40 to construct a combined longer pipe and tank dual spray gun, and because said tank 40 not only can be put on a proper position, but also carried over with the user moving to the working site, therefore the working radium can be increased at will, meanwhile it not only overcomes the demerit of the conventional tin dual spray gun, as like heavy, but also carries on the merit of the conventional pipe dual spray gun, as light and longer working radium, and due to adopting screwing connections between said tank 40 and said pipe 50 in design, even if said tank 40 is overturned by dragging the pipe 50, the sealed tank 40 still can keep the liquid at inside without running off any more, and along with the move of said tank 40, the working radium can be increased infinitely; and said tank 40 not only can be put on the ground, but also put on or hung over in different high position above the ground according to the necessary of the working environment, besides the operator can carry the tank 40 on one hand, the another hand can hold on the spray gun 30 so that the action of processing becomes more rapidly and more facility.

2. Using in pipe method:

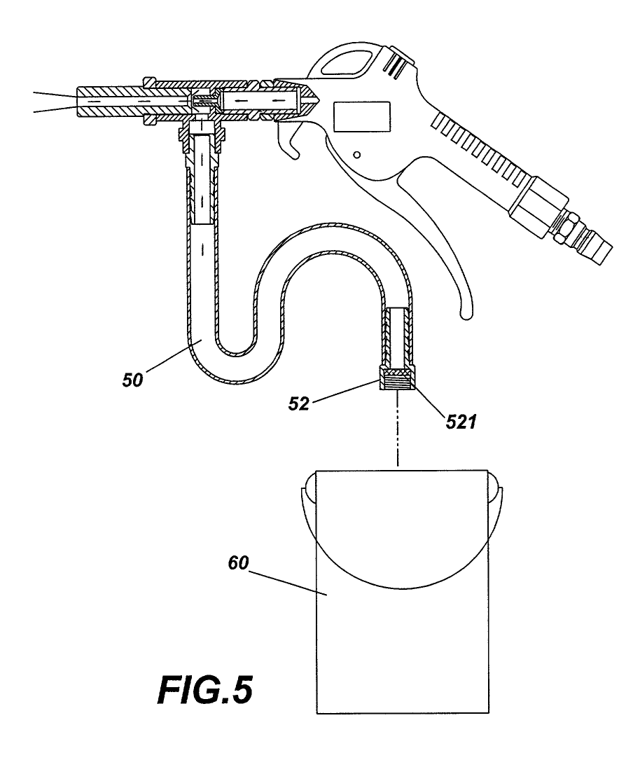

referring to FIG. 5, the filter connection 52 built upon the tip end of said pipe 50 can be used independently, thereby not only filtering foreign with the filter leaf 521 held at inside of said filter connection 52, but also putting in the painting tank 60 directly, whatever small or big one, working as the conventional pipe spray gun; in painting processing, said filter connection 52 can be put into variety of painting tank, and in cleaning processing, the cleaner tank can be used directly by putting in with the filter connection 52 end of said pipe 50.

3. Using in tin method:

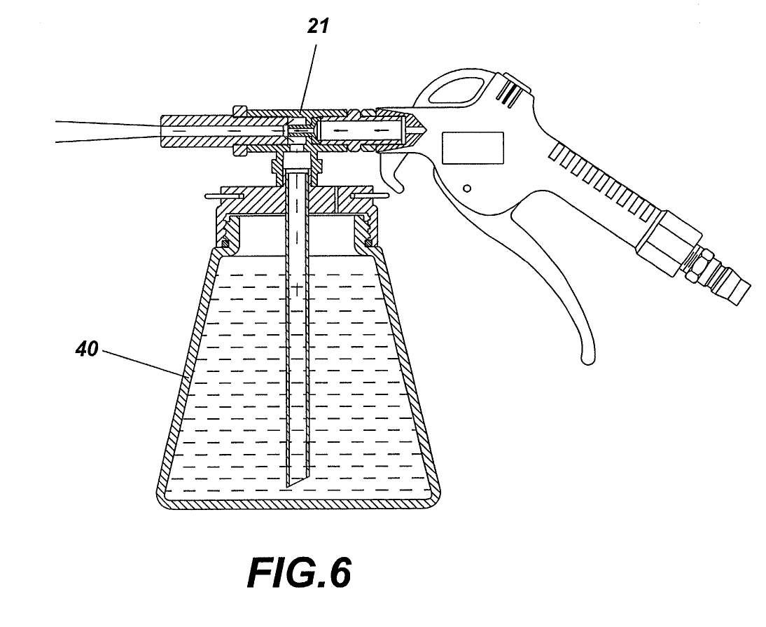

referring to FIG. 6, said tank 40 can be secured on said T-shaped main body 21 to construct a tin dual spray gun for painting and cleaning, like the conventional one, can be selected depending on the necessary of the working environment.

Therefore, according to above-described, we can find out the present invention has following merits:

1. Using in combined tin and pipe method makes the working radium extend infinitely as in painting or cleaning process, meanwhile said tank not only can be set on the different high places, but also can be carry over and according to the necessary of the working environment, it can be moved or placed at will, so it has higher mobility and facility, and without any worry of running off caused by overturning.

2. Combining the tank and said T-shaped main body to form an individual spray gun for using can be applied in a smaller working area and high mobility site.

3. For suiting to a large working area and long working period of the working environment, the present invention can be joined into a pipe dual spray gun by securing the pipe on said T-shaped main body. So the present invention can suit to any working environment by changing the combination style, in three ways, it not only is utilized in various factories, but also in a common family for DIYer using.

I claim:

1. A dual spray gun for painting and cleaning comprised of a three-way T-shaped main body having an inlet tap hole for securing to an air blowgun via a combined bolt and a locating nut, and a front tap hole for securing a blow head, and the downward sucking tap hole connecting to said front tap hole, and a through-hole connecting said front tap hole and said sucking tap hole to said inlet tap hole for locating an atomized nozzle from the inlet tap hole side so that the tip end of said nozzle stretch in the inside of said front tap hole and above said sucking tap hole; said sucking tap hole is used for securing on a pipe connection at one end of a pipe, and a filter connection holding a filter leaf for filtering foreign is built upon the another end of said pipe, and there is an internal screw built on the inside of said filter connection for securing on a bolt with a through-hole at the cap of a tank and sealing with an O-ring, and said combined bolt with a through-hole at the top side of said cap secures with said filter connection, and said cap extends a sucking tube from the bottom side connecting the through-hole of said combined bolt on the top side with top end for sucking up the paint or cleaner in the tank, and said cap also has a pair of pivoting holes for hanging on a handle for carrying over.

2. A dual spray gun for painting and cleaning as claimed in claim 1, wherein said bolt with a through-hole built on the cap of tank can be secured on the sucking tap hole of said T-shaped main body to construct a tin dual spray gun for painting and cleaning.

3. A dual spray gun for painting and cleaning as claimed in claim 1, wherein said vertical sucking tap hole of said main body is just only secured with the pipe connection of said pipe to construct a pipe dual spray gun for painting and cleaning.
